(19) United States
(12) Patent Application Publication
(10) Pub. No.: US 2021/0025801 A1
(43) Pub. Date: Jan. 28, 2021

(54) Experimental Device for Measuring Diffusion Coefficient of Natural Gas

(71) Applicant: Southwest Petroleum University, Chengdu (CN)

(72) Inventors: Shuyong Hu, Chengdu (CN); Jiayi Zhang, Chengdu (CN); Tingting Qiu, Chengdu (CN)

(73) Assignee: Southwest Petroleum University, Chengdu (CN)

(21) Appl. No.: 16/854,581

(22) Filed: Apr. 21, 2020

(30) Foreign Application Priority Data
Jul. 24, 2019 (CN) 201910672768.6

(51) Int. Cl. G01N 13/00; G01N 30/32; G01N 35/00

(52) U.S. Cl. CPC G01N 13/00; G01N 30/32; G01N 2035/009; G01N 2013/003; G01N 2030/326; G01N 35/00722

(57) ABSTRACT

The present invention discloses a new experimental device for measuring a diffusion coefficient of natural gas, mainly including a new core holder, a differential pressure sensor, pressure gauges, multiport valves, a confining pressure pump, a vacuum pump, a hydrocarbon gas source, a nitrogen gas source, a gas chromatograph, an intermediate container, sample chambers, a pressure stabilizing device, and pressure-sensitive alarm devices. A rubber sleeve of the new core holder can prevent a core from being stuck in the holder during core replacement due to an improper operation. The configured pressure stabilizing device is connected to the sample chambers, to ensure stable internal pressure in the chambers after sampling. In this way, one experimental variable is omitted, and an experimental result is more accurate and reliable. If gas leakage occurs. A sensor device can sense the gas leakage in time and sends an alarm to a mobile device of an experimenter.

### CROSS-REFERENCE TO RELATED APPLCATION

This application claims priority to Chinese Application No. 201910672768.6, filed Jul. 24, 2019, which is hereby incorporated by reference.

### TECHNICAL FIELD

The present invention relates to an experimental device, and in particular, to a new experimental device for measuring a diffusion coefficient of natural gas.

### BACKGROUND

A diffusion coefficient of natural gas is an important parameter in gas reservoir engineering. During the study of the percolation theory, a diffusion coefficient of gas is also involved in the description of a diffusion term in a well test model. At present, diffusion coefficient measurement experiments on the market are all carried out according to industry standards, but they generally have some drawbacks. On one hand, during core replacement, a core column needs to be placed at an inlet of a holder, and then it is used to push a core to the middle of the holder. If this operation is carried out improperly, the core will easily get stuck in the holder. Especially, during measurement of brittle cores such as shale, the samples will be directly crushed in case of a seriously improper operation. On the other hand, a part of gas will be released during sampling, resulting in a decrease in internal pressure. In this case, experimental conditions have changed before and after the sampling, and no relatively scientific experimental conditions can be provided. In addition, it usually takes a long time to carry out a diffusion experiment of natural gas. It is hard to discover gas leakage in time once it occurs in a device. Moreover, leakage of methane gas will cause safety risks. Therefore, it is very necessary to improve existing devices for measuring a coefficient of natural gas.

### SUMMARY

An objective of the present invention is to provide a new experimental device for measuring a diffusion coefficient of natural gas, to resolve the problems mentioned above.

The above objective is achieved by the following technical solution in the present invention:

The present invention includes a gas chromatograph, a first measurement valve, a second measurement valve, a differential pressure sensor, a first sample chamber, a second sample chamber, a first pressure gauge, a second pressure gauge, a core holder, a first sampling valve, a second sampling valve, a confining pressure pump, a valve, a piston-type intermediate container, a high-precision constant-speed constant-pressure pump, a vacuum pump, a first multiport valve, a second multiport valve, a first gas source cylinder, a second gas source cylinder, a first pressure-sensitive alarm device, and a second pressure-sensitive alarm device, wherein the gas chromatograph is connected to both the first measurement valve and the second measurement valve; the other ends of the first measurement valve and the second measurement valve are respectively connected to the first sample chamber and the second sample chamber; the first sample chamber and the second sample chamber are respectively connected to the first sampling valve and the second sampling valve; the other end of the first sampling valve is connected to the first pressure gauge, a first end of the differential pressure sensor, the first pressure-sensitive alarm device, and a first end of the core holder; the other end of the second sampling valve is connected to the second pressure gauge, a second end of the differential pressure sensor, the second pressure-sensitive alarm device, and a second end of the core holder; one end of the valve is connected between the first pressure gauge and the second pressure gauge; the other end of the valve is connected to one end of the piston-type intermediate container; the confining pressure pump is connected to the middle part of the core holder; the other end of the piston-type intermediate container is connected to the high-precision constant-speed constant-pressure pump; third ends of the first sample chamber and the second sample chamber are respectively connected to first ends of the first multiport valve and the second multiport valve; second ends of the first multiport valve and the second multiport valve are connected to the vacuum pump; a third end of the first multiport valve is connected to the first gas source cylinder; and a third end of the second multiport valve is connected to the second gas source cylinder.

Further, a rubber sleeve is disposed on a gasket of a plug at one end of the core holder.

Further, the rubber sleeve on the core holder can be directly used to load a core, and can meet both confining pressure loading and heating requirements during an experiment.

Further, a pipeline is externally connected between the sample chamber and the core holder to connect to a pressure regulating system.

Further, the pressure-sensitive alarm device includes a pressure sensor and a single-chip microcomputer; the sensor converts a pressure signal into an electrical signal and sends the electrical signal to the single-chip microcomputer; and the single-chip microcomputer can directly communicate with a Global System for Mobile Communications (GSM) module to send preset alarm information to a mobile device of an experimenter.

Further, a pressure regulating system includes one piston-type intermediate container and one high-precision constant-speed constant-pressure pump; and the pressure regulating system can not only directly change internal pressure but also keep stable internal pressure during the experiment.

Beneficial effects of the present invention are as follows:

The present invention provides a new experimental device for measuring a diffusion coefficient of natural gas. Compared with the prior art, the present invention has a simple structure, and can not only be used for carrying out an experiment for measuring a diffusion coefficient of natural gas in accordance with the provisions in the industry standard, but also effectively alleviate some problems in conventional devices. The beneficial effects mainly include the following several aspects:

(1) In a conventional device, a rubber sleeve is disposed inside a core holder, and an experimental core is pushed by external force into the rubber sleeve from one end of the holder. If this operation is carried out improperly, the core will easily get stuck in the holder. Especially, brittle cores such as shale will be directly crushed in case of a seriously improper operation. In the present invention, a new structure of a holder is designed. A rubber sleeve is disposed on a plug at one end of the holder. For a specific structure of the holder, refer to FIG. 3. During core replacement, a core can be loaded directly onto the rubber sleeve on a gasket, and then loaded into the holder along with the plug. Because of such design, the replacement process becomes easier, and the core can be effectively prevented from being stuck in the holder.

(2) A constant-speed constant-pressure pump can ensure stable internal pressure during an experiment. A part of gas is released from a conventional device during sampling and measurement, resulting in a decrease in internal pressure and changing an experiment condition. In this patent, a new measurement system is designed. A designed pressure stabilizing system can ensure that internal pressure after sampling can be automatically recovered to pressure before sampling, ensuring the consistency of experimental conditions. Moreover, the constant-speed constant-pressure pump can be used to change internal pressure on both sides for carrying out experiments under different internal pressure.

(3) In this patent, a pressure-sensitive alarm device is designed. It usually takes a long time to carry out an experiment for measuring a diffusion coefficient of natural gas. In addition, gas leakage easily occurs after repeated device disassembly. Methane leakage into the indoors even causes safety risks. In this patent, the pressure-sensitive alarm device is designed, which can ensure that if gas leakage occurs in a device, a pressure sensor can sense it in time and alert an experimenter. Therefore, the device in the present invention is of great significance to ensure the safety of experiments.

### BRIEF DESCRIPTION OF DRAWINGS

FIG. 1 is a schematic diagram of an overall structure according to the present invention;

FIG. 2 is a structural schematic diagram of a pressure-sensitive alarm device according to the present invention;

FIG. 3 is a structural schematic diagram of a core holder according to the present invention; and

FIG. 4 is a sectional view of a core holder according to the present invention.

In the figures: 1—gas chromatograph, 2—first measurement valve, 3—second measurement valve, 4—differential pressure sensor, 5—first sample chamber, 6—second sample chamber, 7—first pressure gauge, 8—second pressure gauge, 9—core holder, 10—first sampling valve, 11—second sampling valve, 12—confining pressure pump, 13—valve, 14—piston-type intermediate container, 15—high-precision constant-speed constant-pressure pump, 16—vacuum pump, 17—first multiport valve, 18—second multiport valve, 19—first gas source cylinder, 20—second gas source cylinder, 21—first pressure-sensitive alarm device, 22—second pressure-sensitive alarm device, 211—pressure sensor, 212—single-chip microcomputer, 213—mobile device, 91—rubber sleeve, 92—gasket, and 93—plug.

### DETAILED DESCRIPTION

The present invention is further described in detail with reference to accompanying drawings.

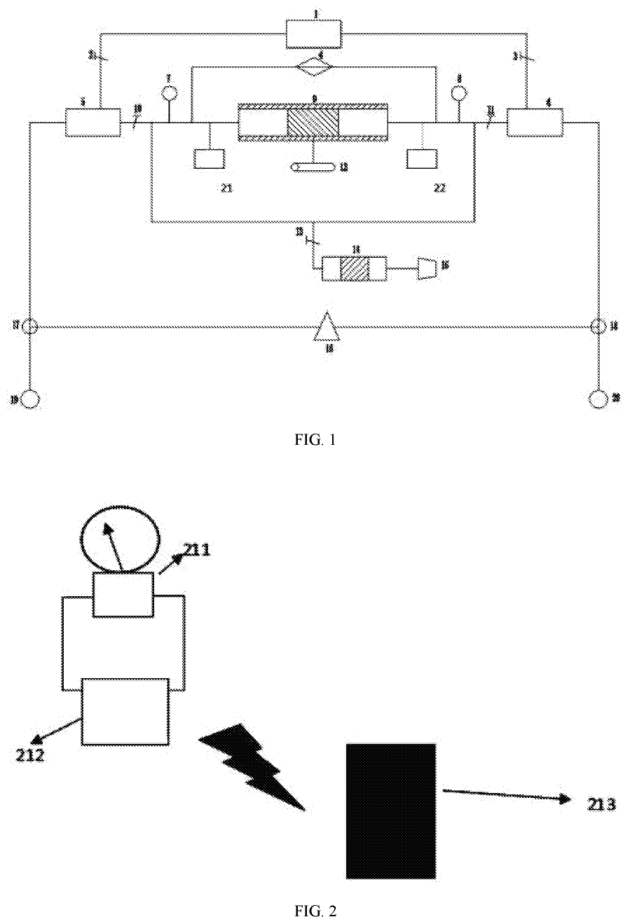

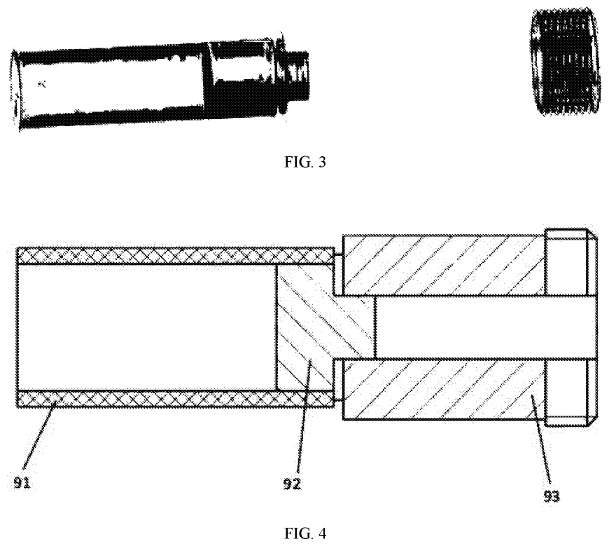

As shown in FIG. 1, the present invention includes a gas chromatograph 1, a first measurement valve 2, a second measurement valve 3, a differential pressure sensor 4, a first sample chamber 5, a second sample chamber 6, a first pressure gauge 7, a second pressure gauge 8, a core holder 9, a first sampling valve 10, a second sampling valve 11, a confining pressure pump 12, a valve 13, a piston-type intermediate container 14, a high-precision constant-speed constant-pressure pump 15, a vacuum pump 16, a first multiport valve 17, a second multiport valve 18, a first gas source cylinder 19, a second gas source cylinder 20, a first pressure-sensitive alarm device 21, and a second pressure-sensitive alarm device 22, where the gas chromatograph is connected to both the first measurement valve and the second measurement valve; the other ends of the first measurement valve and the second measurement valve are respectively connected to the first sample chamber and the second sample chamber; the first sample chamber and the second sample chamber are respectively connected to the first sampling valve and the second sampling valve; the other end of the first sampling valve is connected to the first pressure gauge, a first end of the differential pressure sensor, the first pressure-sensitive alarm device, and a first end of the core holder; the other end of the second sampling valve is connected to the second pressure gauge, a second end of the differential pressure sensor, the second pressure-sensitive alarm device, and a second end of the core holder; one end of the valve is connected between the first pressure gauge and the second pressure gauge; the other end of the valve is connected to one end of the piston-type intermediate container; the confining pressure pump is connected to the middle part of the core holder; the other end of the piston-type intermediate container is connected to the high-precision constant-speed constant-pressure pump; third ends of the first sample chamber and the second sample chamber are respectively connected to first ends of the first multiport valve and the second multiport valve; second ends of the first multiport valve and the second multiport valve are connected to the vacuum pump; a third end of the first multiport valve is connected to the first gas source cylinder; and a third end of the second multiport valve is connected to the second gas source cylinder.

A rubber sleeve 91 is disposed on a gasket 92 of a plug 93 at one end of the core holder.

The rubber sleeve on the core holder can be directly used to load a core, and can meet both confining pressure loading and heating requirements during an experiment.

A pipeline is externally connected between the sample chamber and the core holder to connect to a pressure regulating system.

The pressure-sensitive alarm device includes a pressure sensor 211 and a single-chip microcomputer 212; the sensor converts a pressure signal into an electrical signal and sends the electrical signal to the single-chip microcomputer; and the single-chip microcomputer can directly communicate with a GSM module to send preset alarm information to a mobile device 213 of an experimenter.

Further, a pressure regulating system includes one piston-type intermediate container and one high-precision constant-speed constant-pressure pump; and the pressure regulating system can not only directly change internal pressure but also keep stable internal pressure during the experiment.

An experimental method based on the device includes the following steps:

Step 1: Load a core. The plug at one end, provided with the rubber sleeve, of the core holder 9 is taken out, and the standard core column is screwed into the rubber sleeve to load the plug into the holder.

Step 2: Set an experimental condition. Confining pressure and temperature required for the experiment are set according to the industry standard.

Step 3: Set internal pressure. The multiport valves 17 and 18 are opened, while other valves are closed. Corresponding gases are injected into the two sample chambers according to the experimental condition, and then the valves are closed. Pressure of the constant-speed constant-pressure pump is set to be the same as the internal pressure, and the valve 13 is closed. A lower pressure limit of the pressure sensor is set according to the internal pressure, and then the experiment is carried out, where the gases diffuse themselves.

Step 4: Conduct sampling and measurement. Sampling and measurement are conducted at a regular interval according to the industry standard. After the whole system is vacuumized, the sampling valves 10 and 11 are opened to allow samples to enter the sample chambers 5 and 6. Then, the measurement valves 2 and 3 are opened to allow the sample gases to enter the chromatograph 1 for component analysis.

Step 5: Recover the internal pressure. Because some samples are taken out, the internal pressure is decreased. The sampling valves 10 and 11 are closed, and then the valve 13 is opened. The constant-speed constant-pressure pump automatically increases the pressure to the original internal pressure before sampling. The valve is closed after the pressure is stable, and the gases continue to diffuse.

Step 6: Calculate a diffusion coefficient. After sampling is conducted several times according to the previous steps, a diffusion coefficient is calculated according to the industry standard.

The foregoing displays and describes the basic principles, main features, and advantages of the present invention. It should be understood by those skilled in the art that, the present invention is not limited by the aforementioned embodiments. The aforementioned embodiments and the description only illustrate the principle of the present invention. Various changes and modifications may be made to the present invention without departing from the spirit and scope of the present invention. Such changes and modifications all fall within the claimed scope of the present invention. The protection scope of the present invention is defined by the appended claims and their equivalents.

What is claimed is:

1. A new experimental device for measuring a diffusion coefficient of natural gas, comprising a gas chromatograph, a first measurement valve, a second measurement valve, a differential pressure sensor, a first sample chamber, a second sample chamber, a first pressure gauge, a second pressure gauge, a core holder, a first sampling valve, a second sampling valve, a confining pressure pump, a valve, a piston-type intermediate container, a high-precision constant-speed constant-pressure pump, a vacuum pump, a first multiport valve, a second multiport valve, a first gas source cylinder, a second gas source cylinder, a first pressure-sensitive alarm device, and a second pressure-sensitive alarm device, wherein the gas chromatograph is connected to both the first measurement valve and the second measurement valve; the other ends of the first measurement valve and the second measurement valve are respectively connected to the first sample chamber and the second sample chamber; the first sample chamber and the second sample chamber are respectively connected to the first sampling valve and the second sampling valve; the other end of the first sampling valve is connected to the first pressure gauge, a first end of the differential pressure sensor, the first pressure-sensitive alarm device, and a first end of the core holder; the other end of the second sampling valve is connected to the second pressure gauge, a second end of the differential pressure sensor, the second pressure-sensitive alarm device, and a second end of the core holder; one end of the valve is connected between the first pressure gauge and the second pressure gauge; the other end of the valve is connected to one end of the piston-type intermediate container; the confining pressure pump is connected to the middle part of the core holder; the other end of the piston-type intermediate container is connected to the high-precision constant-speed constant-pressure pump; third ends of the first sample chamber and the second sample chamber are respectively connected to first ends of the first multiport valve and the second multiport valve; second ends of the first multiport valve and the second multiport valve are connected to the vacuum pump; a third end of the first multiport valve is connected to the first gas source cylinder; and a third end of the second multiport valve is connected to the second gas source cylinder.

2. The new experimental device for measuring a diffusion coefficient of natural gas according to claim 1, wherein a rubber sleeve is disposed on a gasket of a plug at one end of the core holder.

3. The new experimental device for measuring a diffusion coefficient of natural gas according to claim 1, wherein the rubber sleeve on the core holder can be directly used to load a core, and can meet both confining pressure loading and heating requirements during an experiment.

4. The new experimental device for measuring a diffusion coefficient of natural gas according to claim 1, wherein a pipeline is externally connected between the sample chamber and the core holder to connect to a pressure regulating system.

5. The new experimental device for measuring a diffusion coefficient of natural gas according to claim 1, wherein the pressure-sensitive alarm device comprises a pressure sensor and a single-chip microcomputer; the sensor converts a pressure signal into an electrical signal and sends the electrical signal to the single-chip microcomputer; and the single-chip microcomputer can directly communicate with a Global System for Mobile Communications (GSM) module to send preset alarm information to a mobile device of an experimenter.

6. The new experimental device for measuring a diffusion coefficient of natural gas according to claim 1, wherein a pressure regulating system comprises one piston-type intermediate container and one high-precision constant-speed constant-pressure pump.
